(19) United States
(12) Patent Application Publication
(10) Pub. No.: US 2009/0172741 A1
(43) Pub. Date: Jul. 2, 2009

(54) CONTENT REPRODUCTION CONTROL APPARATUS, CONTENT REPRODUCTION SYSTEM AND CONTENT REPRODUCTION CONTROL METHOD

(75) Inventor: Tooru Miyazaki, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/234,414

(22) Filed: Sep. 19, 2008

(30) Foreign Application Priority Data
Dec. 27, 2007 (JP) 2007-337103

(51) Int. Cl. H04N 5/445; H04N 7/16

(52) U.S. Cl. 725/56; 725/151

(57) ABSTRACT

A content reproduction control apparatus includes a storage unit storing a table representing in a correlated manner an identifier of at least one device and a radio frequency of a radio signal including a content and being transmitted from the device, a receiving unit receiving the radio signal, a radio intensity calculating unit calculating intensity of the radio signal, a display unit displaying the calculated intensity of the radio signal, and a transmitting unit transmitting to the device a signal instructing to change the intensity of the radio signal using the radio frequency stored in the table.

### CROSS-REFERENCE TO RELATED APPLICATIONS

This application is based upon and claims the benefit of priority from the prior Japanese Patent Application No. 2007-337103, filed on Dec. 27, 2007; the entire contents of which are incorporated herein by reference.

### BACKGROUND OF THE INVENTION

1. Field of the Invention

The present invention relates to a content reproduction control apparatus, a content reproduction system and a content reproduction control method.

2. Description of the Related Art

There is known a technology of a radio communication system to transmit/receive a content via radio communication (for example, refer to JP-A 2005-216451(KOKAI)). With such a radio communication system, a different channel (frequency) can be used to communicate with a plurality of content reproducing devices.

### BRIEF SUMMARY OF THE INVENTION

Here, in a radio communication system, there is a possibility of interference of radio waves on relatively close channels.

An object of the present invention is to provide a content reproduction control apparatus, a content reproduction system and a content reproduction control method, which are able to suppress interference of transmitted/received radio waves and to reliably obtain a content from an externally connected device.

To achieve the above object, a content reproduction control apparatus according to an aspect of the present invention includes a storage unit storing a table representing in a correlated manner an identifier of at least one device and a radio frequency of a radio signal including a content and being transmitted from the device, a receiving unit receiving the radio signal, a radio intensity calculating unit calculating intensity of the radio signal, a display unit displaying the calculated intensity of the radio signal, and a first transmitting unit transmitting to the device a signal instructing to change the intensity of the radio signal using the radio frequency stored in the table.

A content reproduction system according to an aspect of the present invention is a content reproduction system including at least one device and a content reproduction control apparatus transmitting/receiving a radio signal including a content to/from the device. The content reproduction control apparatus includes a storage unit storing a table representing in a correlated manner an identifier of the device and a radio frequency of the radio signal transmitted from the device, a receiving unit receiving the radio signal, a radio intensity calculating unit calculating intensity of the radio signal, a display unit displaying the calculated intensity of the radio signal, and a transmitting unit transmitting to the device a signal instructing to change the intensity of the radio signal using the radio frequency stored in the table. The device includes a radio signal transmitting unit transmitting the radio signal at the radio frequency to the content reproduction control apparatus, a signal receiving unit receiving a signal instructing to change intensity which is transmitted from the content reproduction control apparatus, and a radio intensity changing unit changing intensity of the radio signal based on the received signal.

A content reproduction control method according to an aspect of the present invention includes storing a table representing in a correlated manner an identifier of at least one device and a radio frequency of a radio signal including a content and being transmitted from the device, receiving the radio signal, calculating intensity of the radio signal, displaying the calculated intensity of the radio signal, and transmitting to the device a signal instructing to change the intensity of the radio signal using the radio frequency stored in the table.

### BRIEF DESCRIPTION OF THE DRAWINGS

FIG. 1 is a block diagram showing a structure of a TV system 1.

FIG. 2 is a conceptual diagram showing a table T1.

FIG. 3 is a conceptual diagram showing an example of display of a display unit 113.

FIG. 4 is a schematic diagram showing an example of a radio wave adjusting operation screen.

FIG. 5 is a flowchart showing an operation of creating the table T1 of a TV 100.

FIG. 6 is a flowchart showing an operation of control of an externally connected device 200 or an externally connected device 300 by the TV 100.

FIG. 7 is a flowchart showing an operation of the TV 100 during optimization processing.

FIG. 8 is a block diagram of the TV system 1 including a wired communication unit 710.

FIG. 9 is a sequence diagram according to another example of the TV system 1.

### DETAILED DESCRIPTION OF THE INVENTION

### First Embodiment

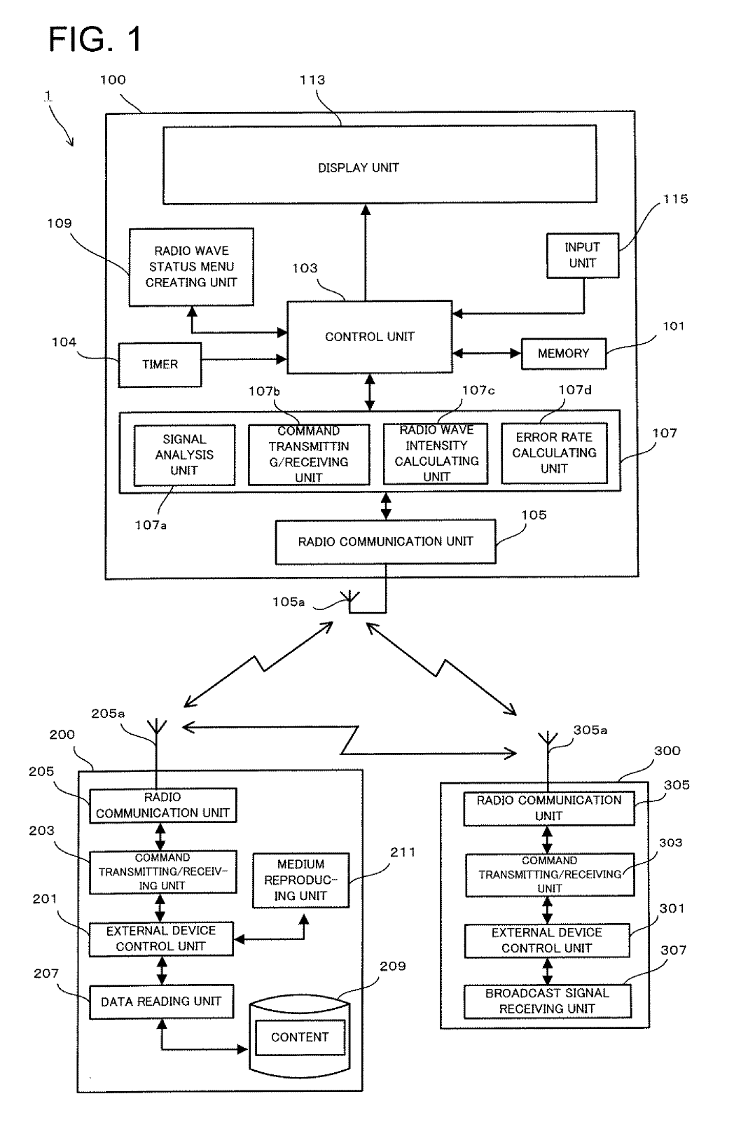

Hereinafter, with reference to the drawings, an embodiment according to one mode of the present invention will be explained in detail. FIG. 1 is a block diagram showing a structure of a TV system 1 according to a first embodiment of the present invention. As shown in the diagram, the TV system 1 is structured by connecting a TV 100 and externally connected devices 200, 300 via a wireless LAN (wireless local area network) or the like.

The devices forming the TV system 1 communicate with each other via radio. The TV 100 communicates with the externally connected devices 200, 300. The externally connected device 200 communicates with the TV 100 and the externally connected device 300. The externally connected device 300 communicates with the TV 100 and the externally connected device 200. For example, a communication signal, a control command S1, a response command S2, which will be described later, and/or the like are transmitted to/received from each other. For example, a radio wave in a frequency band of 2.4 GHz (two point four gigahertz) is used for communication between the devices.

The communication signal is constituted of a content and transmission/reception information. The “content” is, for example, a moving image of the HDMI (High Definition multimedia Interface) standard. Specific examples of the “content” include a moving image (data in the Mpeg2 or Mpeg4 format) of a compressed and recorded TV program, a still image (data in the bitmap, JPEG, PING, GIF format, or the like) from a digital camera (not shown) or the like. Further, as the “content”, for example, there are music data (MP3, AAC, or the like) downloaded from a music distribution service carried out on the Internet and sound data (WAV data) reproduced from a CD in a home. The transmission/reception information is, for example, information indicating the transmitting source of the communication signal or information indicating a transmission destination. Specifically, as the transmission/reception information, there is a unique ID which belongs to a respective device individually. Using the unique ID, each device can identify a device as the target of communication. Further, the transmission/reception information include, together with the unique ID, information of a product name of the externally connected device 200 or the like and information indicating a transmission state of the externally connected device 200.

### (Regarding the TV 100)

The TV 100 is an apparatus that is called, for example, a terrestrial television broadcast receiving apparatus (DTV: Digital terrestrial Television broadcasting tuner), which may be one including a display unit such as a TFT liquid crystal screen or one not including the display unit. In this example, one including a display unit will be explained. The TV 100 functions as a content reproduction control apparatus.

The TV 100 transmits a control command S1 to the externally connected devices 200, 300. By the “control command S1”, it is possible to instruct the externally connected devices 200, 300 to stop transmission of the communication signal or adjust intensity of the radio wave when transmitting the communication signal or the response command S2 (in the explanation below, the “intensity of a radio wave for transmitting the communication signal or the response command S2” will be simply referred to as “intensity of the communication signal”). The control command S1 also includes the transmission/reception information.

The TV 100 receives the response command S2 for the control command S1 from the externally connected devices 200, 300. By the “response command S2”, presence of execution of the control command S1 can be indicated. The response command S2 also includes the transmission/reception information.

The TV 100 includes a memory 101, a control unit 103, a timer 104, a radio communication unit 105, a signal processing unit 107, a radio wave status menu creating unit 109, a display unit 113, and an input unit 115. Further, the TV 100 includes a TV tuner, which is not particularly shown, and can receive a broadcast signal. In the memory 101, a table TO is stored in advance. The table TO represents an identifier for the TV 100 to transmit/receive the communication signal or the like to/from the externally connected devices 200, 300, and an individual frequency corresponding to this identifier. There exist identifiers for channel 1 to channel n (hereinafter, these identifiers will be referred to as channel information). The channel 1 is correlated to a frequency of 2.4 GHz for example. The channel 2 is correlated to, for example, a frequency 40 MHz higher than the frequency of the channel 1.

The control unit 103 controls the memory 101, the timer 104, the radio communication unit 105, the signal processing unit 107, the radio wave status menu creating unit 109, the display unit 113, and the input unit 115 individually. The control unit 103 instructs the externally connected devices 200, 300 to change the intensity of the communication signal or the response command S2. The control unit 103 creates a table T1 and makes the memory 101 retain this table. The table T1 represents, for example, channel information of the table TO and the unique IDs of the externally connected devices 200, 300 in correlation.

The control unit 103 receives the communication signal and the response command S2 from the externally connected devices 200, 300 via the radio communication unit 105. Although not shown, the control unit 103 includes a packet processing unit. The packet processing unit transmits a broadcast radio wave (video, audio radio wave) including a content which is received by the tuner (not shown) to the externally connected device 200 or the externally connected device 300. In addition, this packet processing unit converts the broadcast signal into a communication format of a radio system. The control unit 103 also functions as an encoder/decoder corresponding to respective formats (Mpeg2, Mpeg4, and the like) of contents. The control unit 103 receives an input signal from the input unit 115. The control unit 103 performs various controls based on the input signal from the input unit 115. An example of this control is stopping of transmission of a content of the externally connected device 200 (that is, stopping transmission of the communication signal).

The timer 104 counts a predetermined time (for example, a few seconds to a few tens of seconds). After the control command S1 is transmitted to the externally connected device 200 or the externally connected device 300, the timer 104 is controlled by the control unit 103 to start counting. After counting the predetermined time, the timer 104 notifies the control unit 103 of elapsing of the time. After the elapsing of the time is notified, the timer 104 is reset by the control unit 103. In addition, after the elapsing of the time is notified, the timer 104 itself may reset the count value of its own. By the resetting, the timer 104 counts the predetermined time again.

The radio communication unit 105 functions as a receiving unit which receives a radio signal. The radio communication unit 105 has an antenna 105a. The radio communication unit 105 receives various signals (radio waves) via the antenna 105a. The “various signals” are, for example, the communication signal, the response command S2, and the like transmitted by the externally connected devices 200, 300 to the TV 100. Further, the radio communication unit 105 receives the communication signal transmitted from the externally connected device 300 for example. Moreover, the radio communication unit 105 may receive, for example, a radio wave emitted from a microwave oven or the like.

The radio communication unit 105 transmits the control command S1 or the communication signal including a content extracted from a broadcast wave to the externally connected devices 200, 300 via the antenna 105a.

The radio communication unit 105 demodulates the radio wave received by the antenna 105a and outputs it as a received signal to the signal processing unit 107. The radio communication unit 105 generates information indicating frequencies of the communication signal and the response command S2 received via the antenna 105a and adds the information to the received signal. Based on the information indicating frequencies and the information of frequencies in the table TO, the control unit 103 can correlate the channel information of the table T1 and the externally connected devices 200, 300.

Although not particularly shown, the radio communication unit 105 includes a modulating circuit, a demodulating circuit, and a mixer. The modulating circuit converts the control command S1 and the broadcast signal transmitted to the externally connected devices 200, 300 by the TV 100 into a signal which can be communicated digitally, and converts this signal into a signal in a frequency band used in the radio communication. The demodulating circuit converts the digital signal of a radio system from the externally connected devices 200, 300 received via the antenna 105a into a signal in a frequency band which can be processed in the TV 100. The demodulating circuit further converts this signal into a signal that can be processed by the control unit 103 or the like (this signal is called a baseband signal). The mixer is for processing using one antenna 105a reception of the communication signal from the externally connected devices 200, 300 and transmission of the control command S1 or the like to the externally connected devices 200, 300. Specifically, when there is no mixer, the TV 100 needs to have a plurality of antennas 105a.

The signal processing unit 107 extracts or generates various information from the received signal outputted by the radio communication unit 105. The information extracted (or generated) by the signal processing unit 107 is outputted to the control unit 103 and added to the table T1.

The signal processing unit 107 includes a signal analysis unit 107a, a command transmitting/receiving unit 107b, a radio wave intensity calculating unit 107c, and an error rate calculating unit 107d.

The signal analysis unit 107a extracts transmission/reception information from the received signal outputted by the radio communication unit 105. The signal analysis unit 107a outputs the contents of the extracted transmission/reception information to the control unit 103. When the transmission/reception information could not be extracted from the received signal outputted by the radio communication unit 105, the signal analysis unit 107a outputs information about this to the control unit 103. For example, when the unique IDs of the externally connected devices 200, 300 could not be extracted from the received signal outputted by the radio communication unit 105, the signal analysis unit 107a outputs information indicating that the unique IDs do not exist to the control unit 103.

The command transmitting/receiving unit 107b reads the description of the response command S2 from the received signal outputted by the radio communication unit 105. The command transmitting/receiving unit 107b outputs the read description of the response command S2 to the control unit 103. The command transmitting/receiving unit 107b issues the control command S1 for the externally connected device 200 or the externally connected device 300 and outputs this command to the externally connected device 200 or the externally connected device 300.

The radio wave intensity calculating unit 107c generates information of intensity of the received signal (namely, the communication signal outputted by the externally connected device 200 or the externally connected device 300) outputted by the radio communication unit 105. The information of intensity of the signal is information obtained by digitalizing the intensity (for example, “3” or “5”) of the received signal outputted by the radio communication unit 105. The radio wave intensity calculating unit 107c outputs the information of intensity of the signal to the control unit 103. The radio wave intensity calculating unit 107c has thresholds for determining the minimum and the maximum of intensity of the signal. For example, when the digitalized intensity of the received signal is “1”, it is determined as the minimum, but when it is “5”, it is determined as the maximum. This information of determination is outputted to the control unit 103.

The error rate calculating unit 107d calculates the error rate of a radio wave received by the antenna 105a. The error rate calculating unit 107d outputs the calculated error rate to the control unit 103. The error rate calculating unit 107d has a threshold. This threshold is used for determining whether a content transmitted from the externally connected devices 200, 300 can be reproduced normally or not. The error rate is expressed by “% (percent)”.

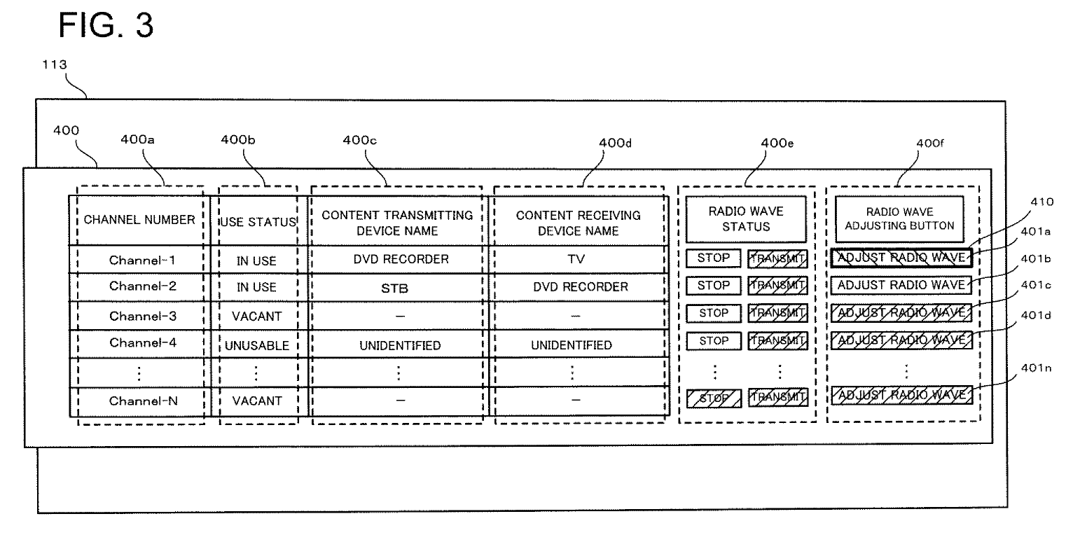

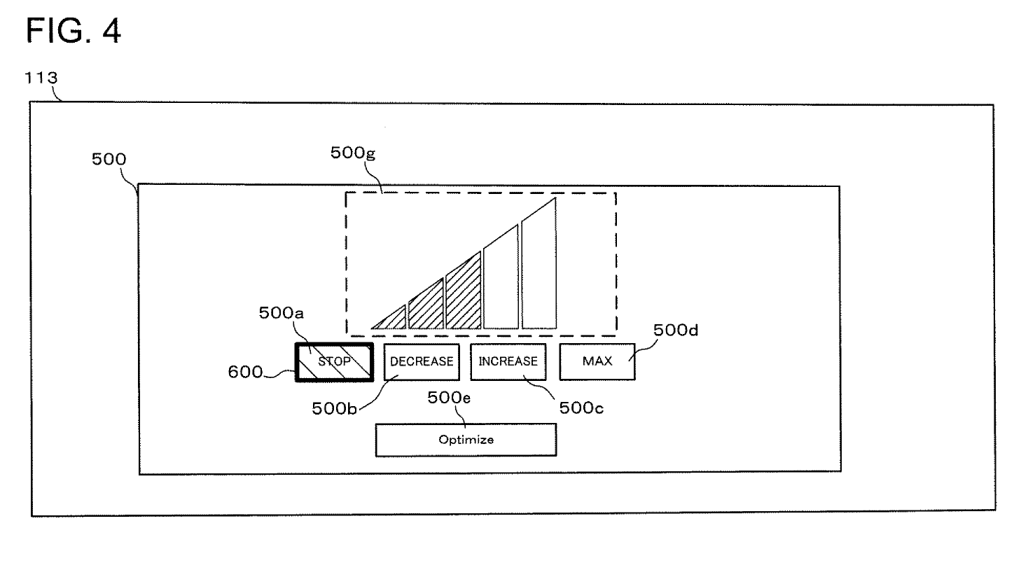

The radio wave status menu creating unit 109 creates a radio wave status menu (refer to FIG. 3). Transmission/reception information included in a radio wave received by the radio communication unit 105, information extracted by the signal processing unit 107, control buttons (for stopping transmission of the communication signal from the externally connected devices 200, 300, adjusting intensity of the communication signal), and the like are correlated and represented on the radio wave status menu. Further, the radio wave status menu creating unit 109 creates a radio wave adjusting operation menu (refer to FIG. 4) for determining stopping of transmission of the communication signal from the externally connected devices 200, 300, adjusting of intensity of the communication signal, and/or the like.

The display unit 113 is a display device constituted of a liquid crystal display panel and so on, and displays a content as well as the radio wave status menu, the radio wave adjusting operation menu, and/or the like created by the radio wave status menu creating unit 109. The display unit 113 also has a graphic engine for displaying and reproducing a content, a speaker, and so on.

The input unit 115 is a device for selecting and deciding a control button from the radio wave status menu or the like displayed on the display unit 113. The input unit 115 is, for example, a touch panel, a set of press-down buttons, a key board, or the like. Further, the input unit 115 may be a receiving device (for example, an infrared receiving device) which receives a command from a not-shown remote controller having buttons corresponding to them.

Using the input unit 115, the user can switch the mode of the display unit 113 from a content reproduction mode to a radio wave status menu display mode and a radio wave adjusting operation menu display mode. For example, when a content is not displayed normally, the user uses the input unit 115 to switch the mode of the display unit 113 to a mode of displaying the radio wave adjusting operation menu. Referring to the radio wave status menu and the radio wave adjusting operation menu displayed on the display unit 113, the user can select a desired one of the externally connected devices 200, 300 which is desired to stop transmission of the communication signal (content) or adjust intensity of the communication signal.

### (Regarding the Externally Connected Device 200)

The externally connected device 200 is a DVD recorder for example. The externally connected device 200 reads a content recorded in a recording medium (DVD-ROM or CD-ROM for example), and performs recording (video recording) or reproduction. The externally connected device 200 has an external device control unit 201, a command transmitting/receiving unit 203, a radio communication unit 205, a data reading unit 207, a content storage unit 209, and a medium reproducing unit 211. The externally connected device 200 can create and retain a table corresponding to the table T1.

The external device control unit 201 controls mainly the command transmitting/receiving unit 203, the radio communication unit 205, the data reading unit 207, and the medium reproducing unit 211. The external device control unit 201 has a function as an encoder corresponding to respective formats (Mpeg2, Mpeg4, and the like) of contents. The external device control unit 201 includes a CPU (Central Processing Unit) and a memory, and performs stopping of transmission of the communication signal, adjusting of intensity of the transmitted radio wave, programming video recording, managing recorded program information, and the like. In this memory, the unique ID of the externally connected device 200, and the like are stored.

The radio communication unit 205 has an antenna 205a. The radio communication unit 205 transmits/receives the control command S1 and the communication signal to/from the TV 100 and the externally connected device 300 via the antenna 205a.

The command transmitting/receiving unit 203 notifies the external device control unit 201 of the description of the received control command S1. The command transmitting/receiving unit 203 issues the response command S2 for the control command S1, and transmits this command to the TV 100.

The content storage unit 209 is, for example, an HDD (Hard Disk Drive) or the like, in which a content transmitted from the TV 100 or the externally connected device 300 is stored. The medium reproducing unit 211 is a device which reads a content stored in, for example, a DVD-ROM.

The externally connected device 200 structured as above is controlled of the transmission state of a radio wave such as the communication signal by the control command S1 from the TV 100. The externally connected device 200 transmits the response command S2 for the control command S1 to the TV 100 based on the state of transmission/reception of the communication signal or the like to/from the externally connected device 300. The externally connected device 200 transmits the response command S2 describing “control command S1 execution-denied” to the TV 100 in the case where, for example, the control command S1 describing to decrease intensity of the transmitted radio wave (communication signal) is received from the TV 100 but it is determined that a problem will occur in communication with the externally connected device 300 by decreasing the intensity of the current communication signal.

### (Regarding the Externally Connected Device 300)

The externally connected device 300 is, for example, an STB (set top box). The STB receives a broadcast signal which cannot be received by the TV 100. As the broadcast signal, there are pay-broadcast radio waves of cable television, broadband VOD (Video On Demand), and the like. The externally connected device 300 converts these broadcast signals into a signal which can be viewed with the TV 100. The externally connected device 300 has an external device control unit 301, a command transmitting/receiving unit 303, a radio communication unit 305, and a broadcast radio wave receiving unit 307. The externally connected device 300 can create and retain a table corresponding to the table T1.

The external device control unit 301 controls mainly the command transmitting/receiving unit 303 and the radio communication unit 305. The external device control unit 301 carries out several controls for device authentication and reception to receive the pay-broadcast radio waves normally. The external device control unit 301 has a CPU and a memory, and adjusts stopping of transmission of the communication signal and intensity of a transmitted radio wave. The unique ID of the externally connected device 300 and so on are stored in this memory.

The radio communication unit 305 has an antenna 305a. The radio communication unit 305 transmits/receives the control command S1, the communication signal, or the like to/from the TV 100 or the externally connected device 200 via the antenna 305a.

The command transmitting/receiving unit 303 notifies the external device control unit 301 of the description of the received control command S1. The command transmitting/receiving unit 303 issues the response command S2 for the control command S1, and transmits this command to the TV 100.

The broadcast radio wave receiving unit 307 receives the broadcast radio wave for cable television or broadband VOD. The broadcast radio wave receiving unit 307 includes, for example, a pay-broadcast receiving unit for receiving the pay-broadcast radio waves, a decryption unit for decrypting codes of the pay-broadcast radio waves, and a decoder unit for demodulating sound/video of pay-broadcasts.

The externally connected device 300 structured as above is controlled of the transmission state of a radio wave such as the communication signal by the control command S1 from the TV 100. The externally connected device 300 transmits the response command S2 for the control command S1 to the TV 100 based on the state of transmission/reception of the communication signal or the like to/from the externally connected device 200. The externally connected device 300 transmits the response command S2 describing “control command S1 execution-denied” to the TV 100 in the case where, for example, the control command S1 describing to decrease intensity of the transmitted radio wave is received from the TV 100 but it is determined that a problem will occur in communication with the externally connected device 200 by decreasing the intensity of the current transmitted radio wave.

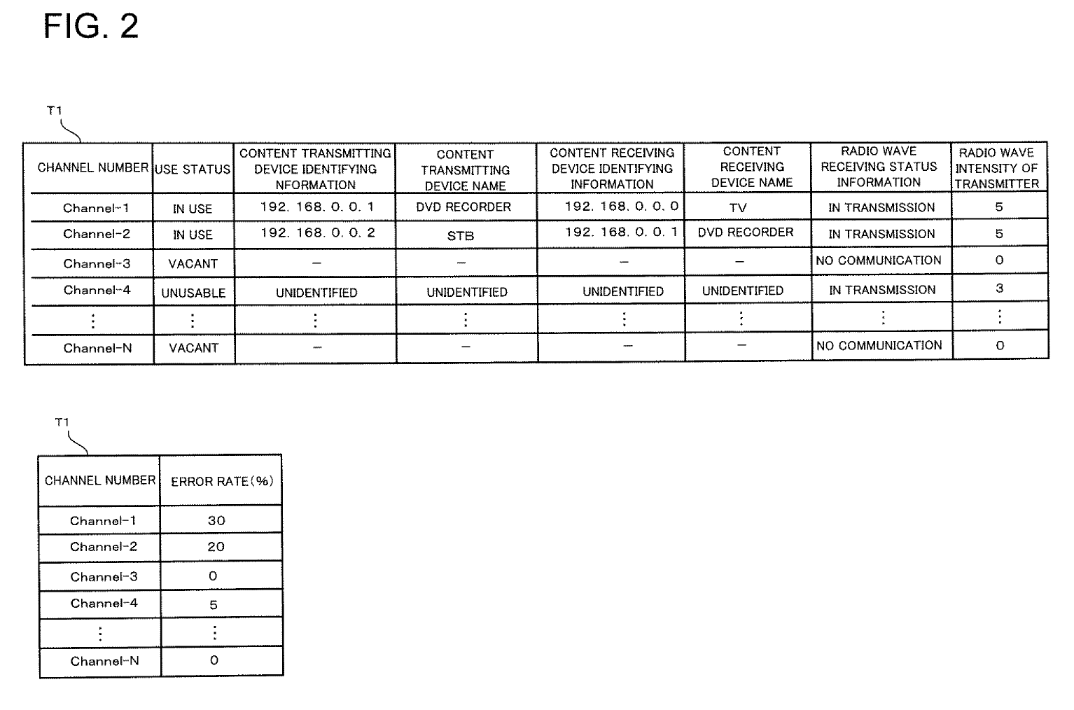

Next, the table T1 will be explained using FIG. 2. FIG. 2 is a conceptual diagram showing the table T1. As shown in the diagram, the table T1 is a table in which a channel number, a use status, content transmitting device identifying information, a content transmitting device name, content receiving device identifying information, a content receiving device name, radio wave receiving status information, radio wave intensity of transmitter, and an error rate are correlated with each other.

The “channel number” is information corresponding to the table T0. Specifically, it is information corresponding to the frequency of a radio wave when the TV 100 transmits/receives the communication signal or the like to/from the externally connected devices 200, 300.

The “use status” is information indicating the use status of a channel number. When a received radio wave includes content transmitting device identifying information or the like, the use status is “in use” (for example, “Channel-1”, “Channel-2”). When a radio wave is received but no content transmitting device identifying information or the like is included, the use status is “unusable” (for example, “Channel-4”). In other cases, the use status is “vacant”.

The “content transmitting device identifying information” is a unique ID belonging to the externally connected device 200 or 300. When no unique ID is included in the communication signal received by the TV 100, information indicating “unidentified” is registered in the table T1.

The “content transmitting device name” is information included in the communication signal received by the TV 100. It is a device name added to the communication signal transmitted by the externally connected device 200 or the externally connected device 300 together with the unique ID. Specifically, it is the product name of the externally connected device 200 or the externally connected device 300 transmitted by the externally connected device 200 or the externally connected device 300.

The “content receiving device identifying information” is information included in the communication signal received by the TV 100. It is information of the unique ID of a device receiving the communication signal transmitted by the externally connected device 200 or the externally connected device 300.

The “content receiving device name” is information included in the communication signal received by the TV 100. The “content receiving device name” is a device name receiving the communication signal transmitted by the externally connected device 200 or the externally connected device 300. This device name is, for example, the product name of the externally connected device 200 or the externally connected device 300 to which the externally connected device 200 or the externally connected device 300 transmitted the communication signal.

The “radio wave receiving status information” is information indicating the state of a device transmitting the communication signal. It is indicated by information “in communication” or “communication stopped”.

The “radio wave intensity of transmitter” is information indicating intensity of a signal calculated by the signal processing unit 107.

The “error rate” is information indicating an error rate of a signal calculated by the signal processing unit 107.

Next, a radio wave status menu 400 displayed on the display unit 113 will be explained using FIG. 3. FIG. 3 is a conceptual diagram showing an example of display on the display unit 113. As shown in the diagram, the display unit 113 displays the radio wave status menu created by the radio wave status menu creating unit 109.

The radio wave status menu 400 is constituted of a predetermined number of information display fields. The radio wave status menu 400 is constituted of a channel number display field 400a, a use status display field 400b, a content transmitting device name display field 400c, a content receiving device name display field 400d, a radio wave status display field 400e, and a radio wave adjusting button display field 400f.

In the content display field 400a, information indicating the “channel number” of the table T1 is displayed. Specifically, channel-1 to channel-N are displayed in the content display field 400a. By the channel numbers displayed in the content display field 400a, the user can easily know the number of channels that can be used in the TV 100.

In the use status display field 400b, information indicating the “use status” of the table T1 is displayed. By displaying the use status, the user can easily know the use status of a channel. Further, the user can easily know which channel should be assigned when newly registering an externally connected device.

In the content transmitting device name display field 400c, information indicating the “content transmitting device name” of the table T1 is displayed. By displaying the transmitting device name, the user can easily know the device currently transmitting a content.

In the content receiving device name display field 400d, information indicating the “content receiving device name” of the table T1 is displayed. By displaying the receiving device name, the user can easily know the device receiving the radio wave from the device currently transmitting a content. Specifically, the user can easily know the relationship between the transmitter and the receiver of the content.

In the radio wave status display field 400e, information indicating the “radio wave receiving status information” of the table T1 is displayed. By displaying the radio wave status, the user can easily know the radio wave transmitting status of the device which currently transmitting a content.

The radio wave adjusting button display field 400f is for stopping or adjusting intensity of the communication signal with respect to the externally connected devices 200, 300. The radio wave adjusting button display field 400f has a plurality of radio wave adjusting buttons 401a to 401n. There exists a number of radio wave adjusting buttons 401a to 401n that corresponds to the number of channel numbers displayed in the content display field 400a.

The radio wave adjusting buttons 401a to 401n are buttons for stopping the communication signal or adjusting intensity of the communication signal with respect to the devices displayed in the content transmitting device name display field 400c. The transmitting device for which adjusting of the communication signal is to be performed is decided by selecting one of the radio wave adjusting buttons 401a to 401n with the input unit 115.

The radio wave adjusting button display field 400f further includes a pointer 410 (the solid frame on the radio wave adjusting button display field 401a). The pointer 410 moves vertically on the radio wave adjusting buttons 401a to 401n by operating the buttons of the input unit 115. One of the radio wave adjusting buttons 401a to 401n overlapping with the pointer 410 is displayed in a manner that it can be distinguished from the other radio wave adjusting buttons 401a to 401n. For example, it is distinguished by inverted characters, outline characters, having a background color different from other areas, or the like.

One of the radio wave adjusting buttons 401a to 401n with the use status display field 400b corresponding to “vacant” or “unusable” is displayed by gray for example, and cannot be selected by the input unit 115. This is because in the device with the use status display field 400b being “vacant” or “unusable” it is not necessary to adjust the communication signal.

Next, a radio wave adjusting operation menu 500 which is displayed on the display unit 113 when one of the radio wave adjusting buttons 401a to 401n is selected with the input unit 115 will be explained using FIG. 4. FIG. 4 is a schematic diagram showing an example of a radio wave adjusting operation screen. As shown in the diagram, the display unit 113 displays the radio wave adjusting operation menu created by the radio wave status menu creating unit 109. The radio wave adjusting operation menu 500 is constituted of radio wave intensity adjusting buttons 500a to 500d, an Optimize button 500e, a radio wave intensity display unit 500g, and a pointer 600.

The radio wave intensity adjusting buttons 500a to 500d are for controlling intensity of the communication signal with respect to the device transmitting a content, and include four types: “stop” button, “decrease” button, “increase” button, and “MAX” button. The “stop” button stops transmission of the communication signal. The “decrease” button” decreases the intensity of the communication signal lower than the current state. The “increase” button increases the intensity of the communication signal higher than the current state. The “MAX” button is for maximizing the intensity of the communication signal.

The Optimize button 500e is for making the TV 100 adjust the intensity of the communication signal automatically.

The radio wave intensity display unit 500g is an indicator for visually displaying information indicating the “radio wave intensity of transmitter” of the table T1. The radio wave intensity display unit 500g displays the “radio wave intensity of transmitter” changed by adjusting the intensity of the communication signal in a manner that the change is reflected successively.

The pointer 600 (the thick frame on the radio wave intensity adjusting button 500a) sequentially moves on the radio wave intensity adjusting buttons 500a to 500d and the Optimize button 500e by the button operation with the input unit 115. One of the radio wave intensity adjusting buttons 500a to 500d and the Optimize button 500e which overlaps with the pointer 600 is displayed in a manner that it can be distinguished from the others of the radio wave intensity adjusting buttons 500a to 500d and the Optimize button 500e. For example, it is distinguished by inverted characters, outline characters, having a background color different from other areas, or the like. By selecting with the input unit 115 one of the radio wave intensity adjusting buttons 500a to 500d and the Optimize button 500e which overlaps with the pointer 600, it is determined to adjust the intensity of the communication signal.

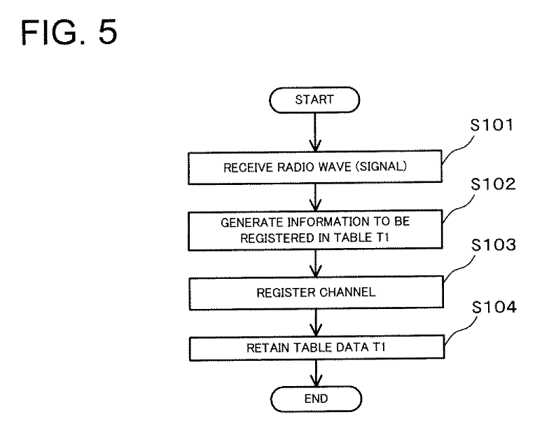

Next, an operation of creating the table T1 by the TV 100 will be explained using FIG. 5. FIG. 5 is a flowchart showing the operation of creating the table T1 of the TV 100. This operation is performed when, for example, the system of the TV 100 is started.

### (1) Receiving the Communication Signal (Step S101)

The radio communication unit 105 receives various signals via the antenna 105a. The radio communication unit 105 demodulates a received signal. At this time, the radio communication unit 105 detects the frequency of the received signal and generates information indicating this frequency. The radio communication unit 105 correlates the demodulated signal with the generated information indicating the frequency and outputs them to the signal processing unit 107.

### (2) Generating Information to be Registered in the Table T1 (Step S102)

The signal processing unit 107 extracts various information from the signal outputted by the radio communication unit 105. Specifically, the signal analysis unit 107a extracts the transmission/reception information included in the signal. The radio wave intensity calculating unit 107c calculates the intensity of the signal. The error rate calculating unit 107d calculates the error rate of the signal. The signal processing unit 107 correlates the extracted information with the information of the frequency of the signal and outputs them to the control unit 103.

### (3) Registering a Channel

From the information outputted from the signal processing unit 107, the control unit 103 sets the channel to be used for communicating with the device which transmitted this information. Based on the information of frequency outputted from the signal processing unit 107 and the table TO stored in the memory 101, one of the channel 1 to channel n is correlated with the device which transmitted the information, and thereby the channel is set.

### (4) Retaining the Table T1 (Step S104)

The control unit 103 correlates the set channel with the various information outputted by the signal processing unit 107 to create the table T1 (refer to FIG. 2), and makes the memory 101 retain the table.

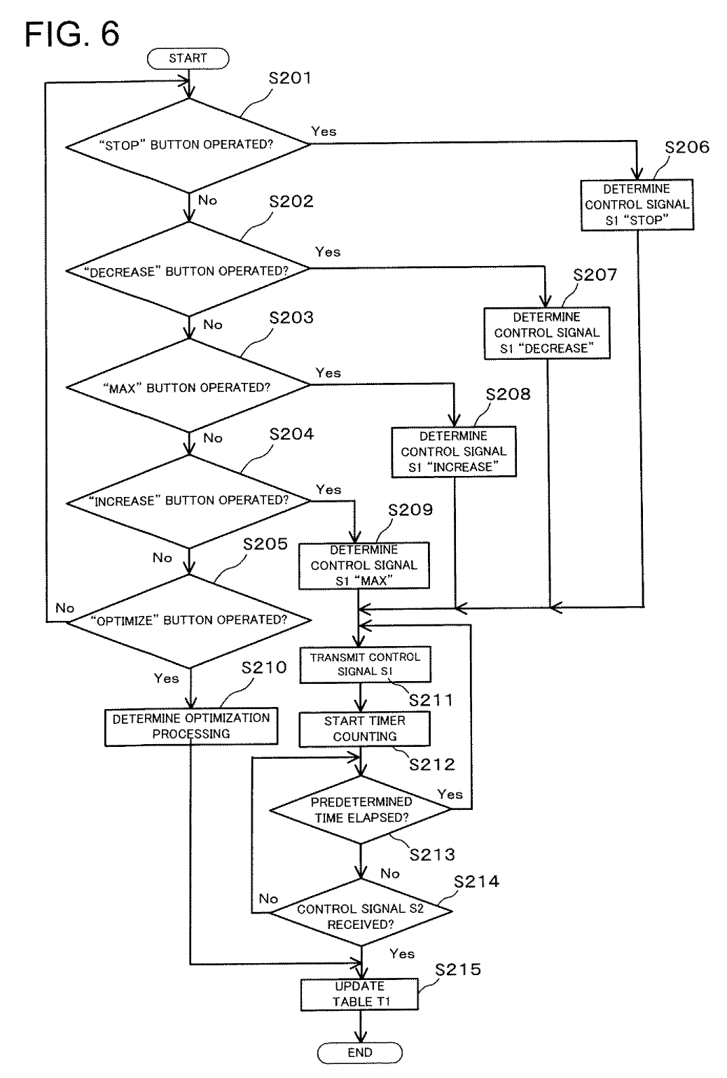

Next, control of transmission of a signal to the externally connected device 200 or the externally connected device 300 by the TV 100 will be explained using FIG. 6. FIG. 6 is a flowchart illustrating an operation of control of the externally connected device 200 or the externally connected device 300 by the TV 100.

Here, the TV 100 reproduces the communication signal transmitted from the externally connected device 200. Specifically, the display unit 113 displays the content. However, there may be a case that the content is not displayed normally on the display unit 113. Possible causes for the content not being displayed normally include that the radio wave transmitted by the externally connected device 200 to the TV 100 is too strong or too weak, the interference by a radio wave of communication between the externally connected device 200 and the externally connected device 300, and the like.

In this case, it is highly possible that controlling the communication state between the devices registered to the channel 2 of the table T1 (for example, between the externally connected device 200 and the externally connected device 300) allows the content to be displayed normally on the display unit 113. Alternatively, it is highly possible that controlling the communication state between the externally connected device 200 and the TV 100 allows the content to be displayed normally on the display unit 113.

The following explanation begins from the state that the user uses the input unit 115 to make the radio wave adjusting operation menu 500 (refer to FIG. 4) of the device using the channel 2 to be displayed on the display unit 113.

### (1) Detecting Operation of a Button (Steps S201 to S205)

The control unit 103 detects whether one of the radio wave intensity adjusting buttons 500a to 500d and the Optimize button 500e of the radio wave adjusting operation menu 500 displayed on the display unit 113 is selected or not by an input operation with the input unit 115.

### (2) Determining Description of the Control Command S1 (Steps S206 to S209)

Based on that one of the radio wave intensity adjusting buttons 500a to 500d and the Optimize button 500e is selected with the input unit 115, the control unit 103 determines the description of the control command S1. Specifically, when the radio wave intensity adjusting button 500a is selected with the input unit 115, the description of the control command S1 becomes “stop transmission of communication signal”. When the radio wave intensity adjusting button 500b is selected with the input unit 115, the description of the control command S1 becomes “decrease intensity of communication signal”.

When the radio wave intensity adjusting button 500c is selected with the input unit 115, the description of the control command S1 becomes “increase intensity of communication signal”. When the radio wave intensity adjusting button 500d is selected with the input unit 115, the description of the control command S1 becomes “maximize intensity of communication signal”.

### (3) Determining Optimization Processing (Step S210)

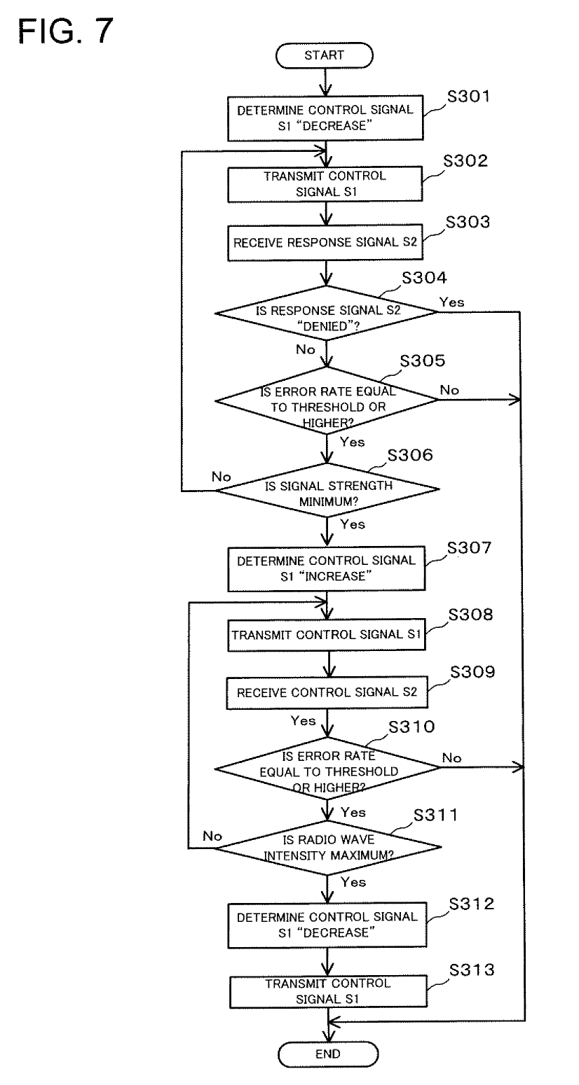

When the Optimize button 500e is selected with the input unit 115, the control unit 103 performs optimization processing. Note that the optimization processing will be explained later using FIG. 7.

### (4) Transmitting the Control Command S1 (Step S211)

The control unit 103 controls the command transmitting/receiving unit 107b to transmit the control command S1 to the externally connected device 200 or the externally connected device 300. The control unit 103 refers to the channel information in the table T1, and makes the control command S1 to be transmitted using the frequency corresponding to the channel. The control command S1 includes description of the control command S1 determined in one of steps S206 to S209, the content transmitting device identifying information registered in the table T1, and the unique ID belonging to the TV 100.

### (5) Starting Counting by the Timer (Step S212)

The control unit 103 makes the timer 104 count a predetermined time corresponding to the transmission of the control command S1.

### (6) Determining Reception of the Response Command S2 (Steps S213 to S214)

The control unit 103 determines reception of the response command S2 from the externally connected device 200 or the externally connected device 300 to which the control command S1 is transmitted. When being notified of elapsing of the time from the timer 104 before receiving the response command S2, the control unit 103 retransmits the control command S1. The control unit 103 repeats the processing of steps S213 to S214 after retransmitting the control command S1.

In addition, when the retransmission of the control command S1 is performed a predetermined number of times, the control of transmission of the signal to the externally connected device 200 or the externally connected device 300 can be interrupted. In this case, the control unit 103 displays on the display unit 113 a message such as “there is no response from the externally connected device 200” and the radio wave status menu screen (refer to FIG. 3). The “predetermined number of times” is not particularly limited, but is three times for example. Information indicating this predetermined number of times may be stored in the memory 101 in advance.

### (7) Updating the Table T1 (Step S215)

The control unit 103 receives the response command S2 from the externally connected device 200 or the externally connected device 300. The control unit 103 updates the table T1 based on the description added to the response command S2. Items to be updated are the “use status”, the “radio wave receiving status information”, the “radio wave intensity of transmitter”, and the “error rate” of the table T1. The description of the response signal added to the response command S2 is, for example, “control command S1 execution-denied” or “control command S1 execution-completed”.

The control unit 103 interrupts processing of the control of transmission of the signal to the externally connected device 200 or the externally connected device 300 when the description added to the response command S2 is “control command S1 execution-denied”. In this case, the control unit 103 makes the display unit 113 display, for example, a message such as “the externally connected device 200 is in communication with another device” and makes the display unit 113 display the radio wave status menu screen (refer to FIG. 3).

Further, when the description added to the response command S2 is “control command S1 execution-completed”, the control unit 103 updates the “radio wave status information” and the “signal intensity” of the table T1 based on the description of the response command S2 and the signal intensity.

Thus, in this TV system 1, when the content is not displayed normally, the intensity of the communication signal transmitted by the externally connected device 200 or the externally connected device 300 can be controlled easily.

### (Regarding the Optimization Processing)

Next, the optimization processing for the externally connected device 200 or the externally connected device 300 will be explained using FIG. 7. FIG. 7 is a flowchart showing an operation of the TV 100 during the optimization processing. Here, it is desirable to perform the optimization processing before displaying a content. Therefore, it will be explained here the case where the optimization processing is performed before displaying the content.

When the intensity of the communication signal is too low, reception at the TV 100 becomes difficult. When the intensity of the communication signal is too high, the waveform when the TV 100 receives the signal is distorted, and the content or the like cannot be displayed. By the optimization processing, for example, the intensity of the communication signal transmitted by the externally connected device 300 is automatically adjusted to be optimum between the TV 100 and the externally connected device 300. The optimization processing can be carried out also between the TV 100 and the externally connected device 200. In addition, the intensity of the signal is desired to be slightly higher than the reception limit of the TV 100.

When the Optimize button 500e is selected with the input unit 115 in the radio wave adjusting operation menu 500 displayed on the display unit 113, the control unit 103 performs the optimization processing (refer to step 210 of FIG. 6).

(1) The Description of the Control Command S1 being Determined as “Decrease Intensity of Communication Signal” (Steps S301 to S302)

The control unit 103 refers to the table T1 and controls, corresponding to the currently displayed radio wave adjusting operation menu 500, transmission of a signal to the device that uses the frequency corresponding to the channel 2. The device currently using the channel 2 is the externally connected device 200 and the externally connected device 300 (refer to FIG. 2). Specifically, the externally connected device 300 is transmitting a content to the externally connected device 200.

First, the control unit 103 transmits the control command S1 to the externally connected device 300. The description of the control command S1 this time is “decrease intensity of communication signal”.

### (2) Receiving the Response Command S2 (Steps S303 to S304)

The control unit 103 receives the response command S2 from the externally connected device 300. When the received response command S2 is “control command S1 execution-denied”, the control unit 103 terminates the optimization processing. When the externally connected device 300 determines that the communication with the externally connected device 200 will be interrupted by the optimization processing, this response command S2 is transmitted. When the response command S2 is “control command S1 execution-completed”, it implies that the externally connected device 300 decreased the intensity of the transmitted radio wave.

### (3) Determining the Error Rate (Step S305)

When the response command S2 is “control command S1 execution-denied” in step S304, the control unit 103 determines that whether or not the error rate of the signal of the externally connected device 300 is equal to a threshold or higher. When the error rate of the signal of the externally connected device 300 is lower than the threshold as a result of the determination, the control unit 103 terminates the optimization processing. This case implies that the control unit 103 determined that the possibility of being able to communicate normally with the externally connected device 300 is quite high. When the error rate of the signal of the externally connected device 300 is equal to the threshold or higher as a result of the determination, the optimization processing is continued.

### (4) Determining the Signal Intensity (Step S306)

The control unit 103 determines whether the signal intensity of the externally connected device 300 is the minimum or not. Note that the “minimum” refers to a state that transmission of the communication signal will be stopped when the intensity of the communication signal is decreased any further. When the signal intensity is not the minimum as a result of the determination, steps S302 to S306 are repeated again. In this case, the reason why the error rate is equal to the threshold or higher may be that the signal transmitted by the externally connected device 300 is too strong.

### (5) Determining the Content of the Control Command S1 as “Increase Intensity of Communication Signal” (Steps S307 to S309).

When the signal intensity is the minimum as a result of the determination in step S306, the control unit 103 determines the content of the control command S1 as “increase intensity of the communication signal”, and transmits this command to the externally connected device 300. When the signal intensity is the minimum as a result of the determination in step S306, the reason why the error rate of the signal is equal to the threshold or higher may be that the signal transmitted by the externally connected device 300 is too weak. The control unit 103 receives the response command S2 for the control command S1 transmitted in step S308.

### (6) Determining Error Rate (Step S310)

The control unit 103 determines the error rate of the communication signal transmitted by the externally connected device 300. When the error rate is lower than the threshold as a result of the determination, the control unit 103 terminates the optimization processing. In this case, it is highly possible to be able to communicate normally with the TV 100 and the externally connected device 300. When the error rate of the signal of the externally connected device 300 is equal to the threshold or higher as a result of the determination, the optimization processing is continued.

### (7) Determining the Signal Intensity (Step S311)

The control unit 103 determines whether the signal intensity of the externally connected device 300 is the maximum or not. Note that the “maximum” refers to the upper limit of the signal intensity which can be transmitted by the externally connected devices 200, 300. When the signal intensity is not the maximum as a result of the determination, steps S308 to S311 are repeated again. In this case, the reason why the error rate is equal to the threshold or higher may be that the signal transmitted by the externally connected device 300 is too weak.

### (8) Terminating the Optimization Processing (Steps S312 to S313)

When the signal intensity is the maximum as a result of the determination in step S311, the communication signal transmitted by the externally connected device 300 turns out to have an error rate that is equal to the threshold or higher even with the signal intensity being changed from the minimum to the maximum. That is, in this optimization processing it is highly possible that the signal intensity of the externally connected device 300 cannot be adjusted automatically. Therefore, the control unit 103 terminates the optimization processing.

Here, when the signal intensity is the maximum as a result of the determination in step S311, the control unit 103 determines the description of the control command S1 as “decrease intensity of communication signal”, and thereafter transmits this command to the externally connected device 300. The reason for determining the description of the control command S1 as “decrease intensity of communication signal” is that when the signal transmitted by the externally connected device 300 is strong, it may adversely affect communication between other devices (for example, the TV 100 and the externally connected device 200).

When terminating the optimization processing, the control unit 103 can display a message, for example, “please adjust the signal intensity of the externally connected device 300 manually” on the display unit 113.

Thus, according to the TV system 1 of this embodiment, communication states among the devices corresponding to the respective channels of the table T1 can be controlled easily.

Note that it is shown here, for simplifying the explanation, the example of connecting only the two externally connected devices 200, 300 to the TV 100, but it is not limited as such. Three or more externally connected devices can be connected to the TV 100. Further, only the externally connected device 200 may be connected to the TV 100.

As explained above, according to the TV system 1 of this embodiment, when a content is not displayed normally on the TV 100, it is possible to easily perform control for the device transmitting the communication signal to adjust intensity of the communication signal or to stop transmission of the communication signal. Specifically, the respective devices can be controlled so that the interference of radiowaves can be suppressed, and the content desired to be displayed on the TV 100 can be obtained securely.

### Other Embodiments

Embodiments of the present invention are not limited to the above embodiment but may be expanded or modified, and any expanded or modified embodiment is included in the technical scope of the present invention.

(1) For example, a new external device can be registered in the TV 100 using the input unit 115. This registration is performed with the radio wave status menu 400 being displayed on the display unit 113. Specifically, a new externally connected device is registered to a channel number with a use status being “vacant” on the radio wave status menu 400. For example, a predetermined operation with the input unit 115 (such as selecting a channel, inputting “register button”), the radio communication unit 105 controlled by the control unit 103 transmits the control command S1 for registration to the externally connected device which is desired to be registered. This control command S1 for registration includes information of a frequency used for communication. The externally connected device transmits the response command S2 to the TV 100 based on this information for registration.

(2) In the above embodiment, the TV 100 and the externally connected device 200 or the externally connected device 300 are connected only via radio. However, a connection via a wired cable (for example, a composite cable or an HDMI cable) 700 or the like is also possible in addition to the connection via radio.

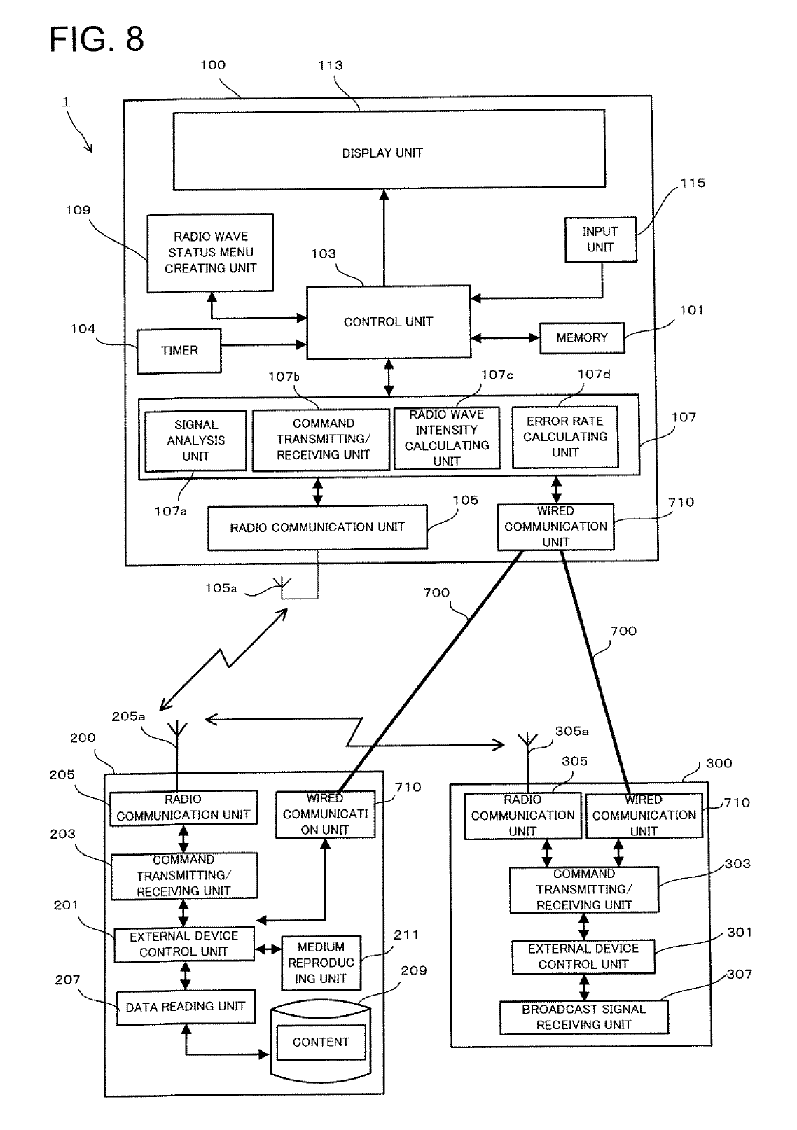

The TV system 1 in this case will be explained using FIG. 8. FIG. 8 is a block diagram of the TV system 1 including a wired communication unit 710. When a content is not displayed normally on the display unit 113, the control unit 103 switches transmission/reception of the communication signal to/from the externally connected device 200 or the externally connected device 300 from radio to the wired cable 700. This switching is instructed by the control command S1.

The TV 100 and the externally connected devices 200, 300 may include the wired communication unit 710 for communication via the wired cable 700. The wired communication unit 710 includes a composite terminal, an HDMI terminal, and the like for connecting the wired cable 700. In addition, the wired communication unit 710 may include various ports such as wired LAN, USB, IEEE1394, and the like. The control unit 103 switches transmission/reception of the communication signal from the radio communication unit 105 to the wired communication unit 710 by, for example, an input operation with the input unit 115. In such a TV system 1, the TV 100 and the externally connected device 200 communicate via radio, and the TV 100 and the externally connected device 300 communicate via the wired cable 700.

(3) In the above embodiment, the externally connected device 200 or the externally connected device 300 is connected to one TV 100, but it may be connected to another TV 101 (not shown) in addition. For example, the externally connected device 200 is connected to the TV 100, TV 101 arranged respectively in adjacent rooms of an apartment. The TV 100 displays a content transmitted from the externally connected device 200. The externally connected device 200 may receive the control command S1 indicating “stop transmission of transmitted radio wave” from the TV 101. The externally connected device 200 can display a warning screen including a message “request for stopping radio wave transmission is issued from TV 101” on the TV 100. This warning screen may include a button “return denial” that can be selected with the input unit 115 which is provided for the TV 100.

Based on selection of the “return denial” button by an input operation with the input unit 115, the externally connected device 200 transmits the response command S2 indicating “control command S1 execution-denied” to the TV 101. When this warning screen is displayed often, the user viewing the content displayed on the TV 100 may be inconvenienced. Accordingly, the externally connected device 200 may set each individual device about whether execution of the control command S1 indicating “stop transmission of communication signal” is possible or not. For example, the externally connected device 200 is configured to stop the signal only when it is transmitted from the TV 100 when the control command S1 (stop transmission of communication signal) is received.

When the control command S1 indicating “stop transmission of communication signal” is transmitted from the TV 101, the externally connected device 200 transmits the response command S2 indicating “control command S1 execution-denied” to this TV 101. This registration is performed using the input unit 115 and the radio wave status menu (refer to FIG. 3) displayed on the display unit 113. This can be registered to a channel with the “use status” being “vacant” on the radio wave status menu. In addition, in such a case, the externally connected device 200 can change the state of transmission of the communication signal as long as the control command S1 has a description other than the “stop transmission of communication signal”.

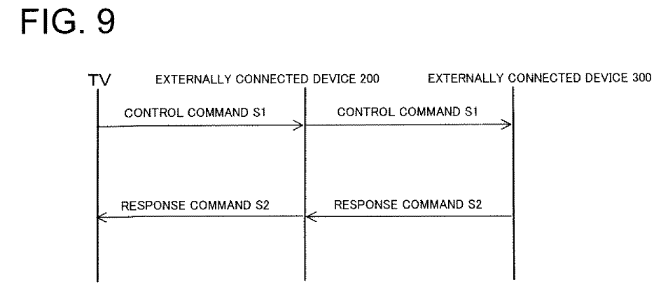

(4) In the above embodiment, the TV 100 transmits the control command S1 directly to the externally connected device 200 or the externally connected device 300. However, this control command S1 can be transmitted to the externally connected device 300 via the externally connected device 200. This case is shown in FIG. 9. FIG. 9 is a sequence diagram according to another example of the TV system 1. The externally connected device 300 can transmit the response command S2 to the TV 100 via the externally connected device 200.

What is claimed is:

1. A content reproduction control apparatus, comprising:
a storage unit storing a table representing in a correlated manner an identifier of at least one device and a radio frequency of a radio signal including a content and being transmitted from the device;
a receiving unit receiving the radio signal;
a radio intensity calculating unit calculating intensity of the radio signal;
a display unit displaying the calculated intensity of the radio signal; and
a first transmitting unit transmitting to the device a signal instructing to change the intensity of the radio signal using the radio frequency.

2. The content reproduction control apparatus according to claim 1, further comprising:
an input unit for input of information instructing the device to change the intensity of the radio signal,
wherein the first transmitting unit transmits the signal based on the input of the information.

3. The content reproduction control apparatus according to claim 2,
wherein the information inputted with the input unit is any one of stopping transmission of the radio signal, increasing the intensity, and decreasing the intensity.

4. The content reproduction control apparatus according to claim 1, further comprising:
an error rate calculating unit calculating an error rate of the received radio signal;
a comparison unit comparing the error rate with a predetermined threshold; and
a radio intensity changing unit causing the first transmitting unit to transmit a signal instructing to change the radio intensity of the radio signal to the device based on a result of comparison in the comparison unit.

5. The content reproduction control apparatus according to claim 4, further comprising:
a determination unit determining a minimum and a maximum of the radio intensity,
wherein the radio intensity changing unit causes the first transmitting unit to transmit a signal instructing to decrease the radio intensity when the radio intensity is not the minimum as a result of determination in the determination unit and the error rate is higher than the threshold.

6. The content reproduction control apparatus according to claim 4,
wherein the radio intensity changing unit causes the first transmitting unit to transmit a signal instructing to increase the radio intensity when the radio intensity is the minimum as a result of determination in the determination unit and the error rate is higher than the threshold.

7. The content reproduction control apparatus according to claim 1, further comprising:
a second receiving unit receiving a signal including a content from the device via a wire; and
a second transmitting unit transmitting to the device a signal instructing to transmit the signal including the content via the wire,
wherein when the second transmitting unit transmits to the device the signal instructing to transmit the signal including the content via the wire, the first transmitting unit stops transmission of the radio signal to the device.

8. The content reproduction control apparatus according to claim 1, further comprising a second display unit displaying a content transmitted from the device.

9. A content reproduction system comprising at least one device and a content reproduction control apparatus transmitting/receiving a radio signal including a content to/from the device,
the content reproduction control apparatus comprises:
a storage unit storing a table representing in a correlated manner an identifier of the device and a radio frequency of the radio signal transmitted from the device;
a receiving unit receiving the radio signal;
a radio intensity calculating unit calculating intensity of the radio signal;
a display unit displaying the calculated intensity of the radio signal; and
a transmitting unit transmitting to the device a signal instructing to change the intensity of the radio signal using the radio frequency stored in the table, and
the device comprises:
a radio signal transmitting unit transmitting the radio signal at the radio frequency to the content reproduction control apparatus;
a signal receiving unit receiving a signal instructing to change intensity which is transmitted from the content reproduction control apparatus; and
a radio intensity changing unit changing intensity of the radio signal based on the received signal.

10. The content reproduction system according to claim 9, further comprising:
an input unit for input of information instructing the device to change the intensity of the radio signal,
wherein the first transmitting unit transmits the signal based on the input of the information.

11. The content reproduction system according to claim 10,
wherein the information inputted with the input unit is any one of stopping transmission of the radio signal, increasing the intensity, and decreasing the intensity.

12. The content reproduction system according to claim 9,
wherein the content reproduction control apparatus further comprises:
an error rate calculating unit calculating an error rate of the received radio signal;
a comparison unit comparing the error rate with a predetermined threshold; and
a radio intensity changing unit causing the first transmitting unit to transmit a signal instructing to change the radio intensity of the radio signal to the device based on a result of comparison in the comparison unit.

13. The content reproduction system according to claim 12,
wherein the content reproduction control apparatus further comprises a determination unit determining a minimum and a maximum of the radio intensity, and
wherein the radio intensity changing unit causes the first transmitting unit to transmit a signal instructing to decrease the radio intensity when the radio intensity is not the minimum as a result of determination in the determination unit and the error rate is higher than the threshold.

14. The content reproduction system according to claim 12,
wherein the radio intensity changing unit causes the first transmitting unit to transmit a signal instructing to increase the radio intensity when the radio intensity is the minimum as a result of determination in the determination unit and the error rate is higher than the threshold.

15. The content reproduction system according to claim 9,
wherein the content reproduction control apparatus further comprises:
a second receiving unit receiving a signal including a content from the device via a wire; and
a second transmitting unit transmitting to the device a signal instructing to transmit the signal including the content via the wire, and
wherein when the second transmitting unit transmits to the device the signal instructing to transmit the signal including the content via the wire, the first transmitting unit stops transmission of the radio signal to the device.

16. The content reproduction system according to claim 9, further comprising
a second display unit displaying a content transmitted from the device.

17. A content reproduction control method, comprising:
storing a table representing in a correlated manner an identifier of at least one device and a radio frequency of a radio signal including a content and being transmitted from the device;
receiving the radio signal;
calculating intensity of the radio signal;
displaying the calculated intensity of the radio signal; and
transmitting to the device a signal instructing to change the intensity of the radio signal using the radio frequency stored in the table.

18. The content reproduction control method according to claim 17, further comprising:
inputting information instructing the device to change the intensity of the radio signal,
wherein, in the transmitting, the signal is transmitted based on the input of the information.

19. The content reproduction control method according to claim 18,
wherein the information inputted is any one of stopping transmission of the radio signal, increasing the intensity, and decreasing the intensity.

20. The content reproduction control method according to claim 17, further comprising:
calculating an error rate of the received radio signal;
comparing the error rate with a predetermined threshold; and
causing a signal instructing to change the radio intensity of the radio signal to be transmitted based on a result of the comparison.
